(19) United States
(12) Patent Application Publication
(10) Pub. No.: US 2010/0021873 A1
(43) Pub. Date: Jan. 28, 2010

(54) STRESS REDUCTION

(75) Inventors: Wilhelmus Johannes Joseph Stut, Eindhoven (NL); Petronella Hendrika Pelgrim, Eindhoven (NL); Richard Vdovjak, Eindhoven (NL); Privender Kaur Saini, Eindhoven (NL); Joanne Henriette Desiree Monique Westerink, Eindhoven (NL); Frank Wartena, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/515,847

(22) PCT Filed: Nov. 20, 2007
(86) PCT No.: PCT/IB2007/054713

§ 371 Date: May 21, 2009

(30) Foreign Application Priority Data
Nov. 28, 2006 (EP) 06124905.8

(51) Int. Cl. G09B 19/00

(52) U.S. Cl. 434/236

(57) ABSTRACT

According to the method and system described the usage of keyboard and mouse by a computer user is analyzed (20). Based thereon, it may be proposed to the user to take a break and to do a small mental game, puzzle, or brain exercise (50). This may help reduce stress, to relax, to increase concentration, to reduce mental fatigue, and to make the user's memory and brains function better.

### BACKGROUND OF THE INVENTION

The present invention relates to a method, software and a system for reducing stress.

### DESCRIPTION OF RELATED ART

Several surveys show that many people suffer from stress at work. For example, a survey by Northwestern National Life indicates that 40% of workers report that their job is very or extremely stressful. A survey by Yale University indicates that 29% of workers report that they feel quite a bit or extremely stressed at work. It has been reported that high stress yearly generates a cost of $136 per employee, making stress very expensive for employers.

According to the National Institute for Occupational Safety and Health (NIOSH, see http://www.cdc.gov/niosh/stresswk.html), job stress can be defined as the harmful physical and emotional responses that occur when the requirements of the job do not match the capabilities, resources, or needs of the worker. Job stress can lead to poor health and even injury.

Computer tools that stimulate the user to take a break and to do physical exercises (such as Workpace) are available. However, these tools focus on physical complaints, in particular on complaints related to RSI (or CANS). The exercises suggested by these tools make the user stretch muscles in the neck, arms, hands, and shoulders.

Although a side effect of these exercises may be that the user feels better mentally, the primary objective of these tools is to reduce physical complaints. Furthermore, after using these tools for a while, the user knows the proposed exercises by heart, and can continue to think about his work while doing the exercises. Hence the effect of these tools on mental wellbeing is very limited. What might also hinder the user to perform the physical exercises (especially in open offices) is a feeling of shame because colleagues can oversee the user's actions.

U.S. Pat. No. 6,484,062 B1 discloses a computer system to relax stress responses such as fatigue, VDT syndrome or occupational diseases possibly gained from long hours of computer usage. This computer system is able to divert the negative effects of conventional computer usage to affirmative effects by introducing e.g. aroma therapy. The computer system provides not only the data programs of establishing, playing, execution and controlling, but also the stress relief program comprising acoustic therapy, color therapy, fragrance therapy and tactual therapy and a stress perception program. The stress relief program is actuated by an emission device through a converter. The equipment of the stress relief is installed on a peripheral device of a computer such as a speaker, keyboard or monitor. The computer system for stress relaxation comprises a combination of the computer system and natural therapies applied to the human senses like sight, audition, touch and smell. With this computer system, the computer user has a merit of stress relief during the computer operating. However, it is a drawback of this known system that a computer offering all these therapies to the user is rather complicated and expensive to implement.

It is an objective of the invention to provide a method and system to reduce stress, in particular mental fatigue, which is effective and easy to implement.

### SUMMARY OF THE INVENTION

This and other objectives of the invention are achieved by a method according to claim 1, a computer program according to claim 14 and a system according to claim 17. Favorable embodiments are defined by the dependent claims 2-13, 15-16 and 18.

According to an aspect of the invention a method is provided for reducing stress. First, it is determined if a break is to be proposed to a user. When the break is proposed to the user, the user is invited to do a mental exercise. Having regular breaks and doing small mental exercises may help to reduce stress, to relax, to increase concentration, to reduce mental fatigue, and to make the memory and brains function better. In this way the user's mental wellbeing is improved. According to the invention the user is stimulated to take a break and to do these mental exercises and therefore does not need to rely on his own discipline for this. Furthermore, the method according to the invention is easy to implement.

The mental exercises may be mental games, puzzles or brain exercises, such as Sudoku, Tic-tac-toe, jigsaw puzzles, exercises to remember words through visualization, etc. An exercise or game may be started during a first break and continued during a further, later break.

The method according to the invention is preferably used for workers on computers in an office environment. However, it may also be implemented in other working environments where stress or mental fatigue of workers exists, such as an assembly line.

According to an embodiment, it is determined if a break is to be proposed to a user by measuring the time that has elapsed since the user has started an activity, or the time that has elapsed since the previous mental exercise break. When the measured time exceeds a predefined value it is decided to propose the break.

A default value for the predefined value can be set according to large scale investigations on averages amongst multiple users. So how long does the average non-stressed person spend continued time working on the computer? This time can be set as the maximum default allotted time for ‘undisturbed work’ and the system may interrupt the person for a mental exercise break when the continued time working on the computer exceeds this value.

According to a further embodiment, the user is invited to a mental exercise break at predetermined times, e.g. every 50 minutes. This embodiment can be very easily implemented.

According to a still further embodiment it is determined if a break is to be proposed to a user by measuring a parameter indicative of the stress of a user. It is decided to propose the break or not, based on the value of the measured parameter. In this way, breaks are only proposed when it is necessary and unnecessary break proposals to users, that are not stressed, are avoided.

According to a first alternative of this embodiment, it is determined if a break is to be proposed to a user by counting the number of actions performed by the user during a predetermined time interval, and by deciding to propose the break when the number exceeds a predefined value. The number of actions performed by the user per time interval may be an indicator of the user's stress or mental fatigue. In case that the user is a worker on a computer system, the actions may be the number of key strokes or mouse clicks per time interval.

Alternatively or additionally, it is determined if a break is to be proposed to a user by counting the number of errors made by the user or the number of corrections of errors made by the user during a time interval, and deciding to propose the break when the number exceeds a predefined value. In case that the user is a worker on a computer system, the number of corrections of errors may be counted by counting the number of times the Backspace or Delete button has been used, or how many times the user has selected an “Undo” option or typed Ctrl-Z per time interval (e.g. 30 minutes). The underlying assumption is that if a user makes more typing errors than normal, he is less concentrated, and needs a mental exercise break.

When, as according to these embodiments, the user's keyboard and mouse usage is used to determine the next mental exercise break, one should realize that different persons have different usage patterns, even when they are relaxed. For this reason the predefined value to be used to decide if the user is invited to a mental exercise break should be based on a personal user pattern. This pattern can be built by:

monitoring the person's keyboard and mouse usage for a certain period of time (e.g. weeks), and by asking the person at certain moments whether he feels stressed (e.g. “please indicate your current stress level: no stress—medium stress—high stress”).

letting the user type a certain text, and by asking the person whether he feels stressed at this moment (e.g. “please indicate your current stress level: no stress—medium stress—high stress”).

By combining the usage data and answers, the next mental exercise break can be determined more accurately.

Alternatively or additionally, it is determined if a break is to be proposed to a user by measuring a physiological parameter of the user indicative of stress, and by deciding to propose the break or not based on the value of this physiological parameter. Some physiological values such as body temperature or Galvanic Skin Response (GSR) may be indicative of mental fatigue of the user. Therefore, they may advantageously be used to trigger a mental exercise break.

According to a further preferred embodiment, the user is enabled to choose a mental exercise from a mental exercise library. This allows the user to vary the mental exercise per break according to his taste and mood, resulting in a good stress reducing effect.

According to an embodiment, the performance of any further actions by the user is inhibited until he has completed the mental exercise. In case that the method is employed in a computer system, this may be done by disabling the computer applications other than the mental break exercises. In this way, the user is obliged to take his mental exercise break before continuing work. However, it is preferred that the user is in control and may ignore the invitation, and continue working or, alternatively quit the exercise before it is finished.

Preferably, the method according to the invention is implemented by means of a computer program.

According to a further aspect of the invention a system is provided for reducing stress comprising:

determining means for determining if a break is to be proposed to a user;

invitation means for inviting the user to do a mental exercise, when the break is proposed to the user.

These and other aspects of the invention will be apparent from and elucidated with reference to the embodiments described hereinafter.

### BRIEF DESCRIPTION OF THE DRAWINGS

The invention will be better understood and its numerous objects and advantages will become more apparent to those skilled in the art by reference to the following drawing, in conjunction with the accompanying specification, in which:

FIG. 1 shows a flow chart of the method according to the invention.

FIG. 2 shows a block diagram of a system for implementing the method according to the invention.

Throughout the figures like reference numerals refer to like elements.

### DETAILED DESCRIPTION OF THE PRESENT INVENTION

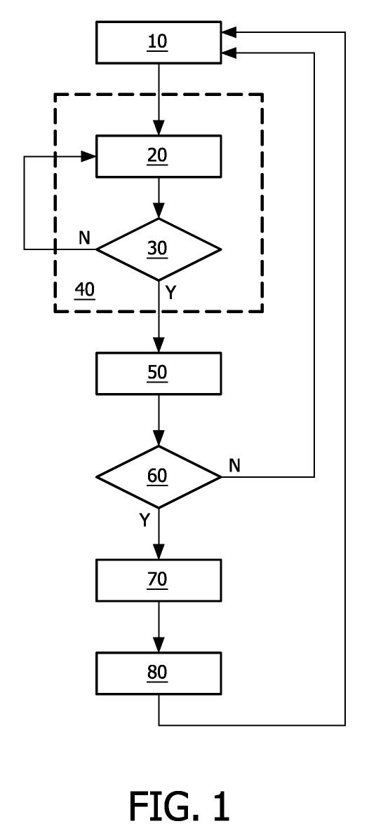

With reference to FIG. 1 a flow chart of the method according to the invention is described. Preferably, the method according to the invention is implemented for reducing mental stress of workers on computer systems in an office environment but it may also be used for stress reduction in other working environments, such as assembly lines.

After turning the computer on, at step 10 the method is initialized. In the next step (step 20), a parameter indicative of the mental fatigue of a computer user is measured. In step 30 it is decided to propose a mental exercise break or not. If the value of the measured parameter indicates that the user is stressed then a break is proposed and the user is invited to play a mental exercise (step 50) as described herein after. If this is not the case, step 20 is repeated. Steps 20 and 30 together are the determining step 40 for determining if a break is to be proposed to a user.

When focusing on workers using a computer, the following possibilities exist for implementing steps 20 and 30 to determine the moment of the next mental exercise break, by using a parameter indicative of the mental fatigue of a computer user:

the number of key strokes or mouse clicks per time interval (e.g. 30 minutes) is counted (step 20). When this number exceeds a predefined value (as determined in step 30), the user is invited to do a mental exercise. The underlying assumption is that a high number of keystrokes or mouse clicks per time interval is an indication of user stress. the number of times the Backspace or Delete button has been used, or how many times the user has selected the “Undo Typing” option or typed Ctrl-Z per time unit (e.g. 30 minutes) is counted (step 20). When this number exceeds a predefined value (as determined in step 30), the user is invited to do a mental exercise. The underlying assumption is that if a user makes more typing errors than normal, he is less concentrated, and needs a mental rest break.

A physiological parameter of a user, which is indicative of stress, is measured, such as the body temperature or GSR (step 20). When the measured parameter has a value indicative of undesirable stress of the user (as determined in step 30), the user is invited to do a mental exercise. In case that the physiological parameter is the body temperature, the user could be invited to do the mental exercise when the temperature is over a predefined value.

When using a person's keyboard and mouse usage to determine the next mental exercise break, one should realize that different persons have different usage patterns, even when they are relaxed. To circumvent this, the system should have a personal keyboard and mouse usage pattern. This pattern can be built by:

monitoring the person's keyboard and mouse usage for a certain period of time (e.g. weeks), and by asking the person at certain moments whether he feels stressed (e.g. “please indicate your current stress level: no stress—medium stress—high stress”).

letting the user type a certain text, and by asking the person whether he feels stressed at this moment (e.g. “please indicate your current stress level: no stress—medium stress—high stress”).

By combining the usage data and answers, the system can determine the next mental exercise break more accurately.

It is possible to determine the moment of a next break by using other parameters than the parameters indicating user stress. These parameters can be used as an alternative to parameter indicative of the stress of a user, or in addition thereto.

According to a first possibility, the time is measured that has elapsed since the user has started to use the computer, or that has elapsed since the previous mental exercise break (step 20). When this time exceeds a predefined value (as determined in step 30), the system invites the user to do a mental exercise.

According to a second possibility, the system simply suggests to take a mental exercise break every n minutes, e.g. every 50 minutes.

A default value for the predefined value mentioned in the first possibility can be set according to large scale investigations on averages. So how long does the average non-stressed person spend continued time working on the computer? This time can be set as the maximum default allotted time for ‘undisturbed work’ and the system may interrupt the person for a mental exercise break when the continued time working on the computer exceeds this value. As alternative we may use values that are already known (optimal performance with 45-50 minutes concentrated work followed by 10-15 minute break).

When the system has determined that the user shall do a mental exercise, a small window appears on the screen, announcing that the system will launch a mental exercise and inviting the user to participate (step 50). The user may accept the invitation or he may ignore the invitation, and continue working (step 60). In case that the user does not accept the invitation, the method is reinitiated (step 10). In an alternative embodiment, the system may disable other computer applications until the user has done the mental exercise.

If the user accepts the invitation, he is offered a selection of mental exercises from a mental exercise library of which he may choose one (step 70). In step 80 the user performs the mental exercise. The user can quit the exercise at any time. After the exercise, he continues his normal work in the computer and the method is reinitiated (step 10). A game or exercise which is not finished by a user during a break may be continued during a later break.

The mental exercise library contains a collection of mental games, puzzles, and brain exercises (that train the brains). When focusing on workers using a computer, the collection of games, puzzles and exercises includes (but is not limited to) the following:

Sudoku

Tic-tac-toe

jigsaw puzzle

an exercise to remember words via visualization

etc.

The user may add his own favorite mental games, puzzles, and brain exercises to the library.

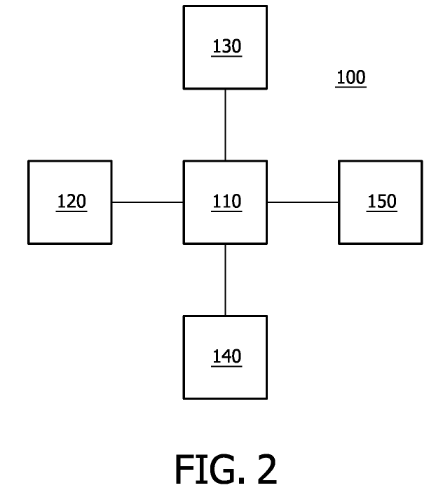

FIG. 2 illustrates a computer system 100 for implementing the method according to FIG. 1. It shows a processor 110, a memory 120, a display 130, an input means 140 (keyboard and mouse), and communication means 150. In this embodiment the processor 110 executes instructions stored in the memory 120, according to the method of FIG. 1. The input means 140 are used to obtain information to determine the moment of the next mental exercise break. The communication means 150 can be used for exchanging information with external systems (e.g. for adding new mental exercises or for adding a device to measure the user's physiological data). The display 130 is used to inform the user that a mental exercise is to be done, and to invite the user to participate.

As will be recognized by those skilled in the art, the innovative concepts described in the present application can be modified and varied over a wide range of applications.

Accordingly, the scope of patented subject matter should not be limited to any of the specific exemplary teachings discussed, but is instead defined by the following claims.

Any reference signs in the claims shall not be construed as limiting the scope thereof.

1. Method for reducing stress comprising the following steps:
determining if a break is to be proposed to a user (40);
when the break is proposed to the user, inviting the user to do a mental exercise (50).

2. Method according to claim 1 wherein the determining step (40) comprises the steps of:
measuring the time that has elapsed since the user has started an activity, or the time that has elapsed since the previous mental exercise break (20), and
deciding to propose the break, when the measured time exceeds a predefined value (30).

3. Method according to claim 2 wherein the predefined value is determined according to investigations on averages amongst multiple users.

4. Method according to claim 1 wherein the determining step comprises the step of deciding to propose the break at predetermined times.

5. Method according to claim 1 wherein the determining step comprises the steps of:
measuring a parameter indicative of the stress of a user (20);
deciding to propose the break or not, based on the value of the measured parameter (30).

6. Method according to claim 5 wherein the parameter is the number of actions performed by the user during a predetermined time interval, and wherein it is decided to propose the break when the number exceeds a predefined value.

7. Method according to claim 5 wherein the parameter is the number of errors made by the user or the number or corrections of errors made by the user during a time interval, and wherein it is decided to propose the break when the number exceeds a predefined value.

8. Method according to claim 6, wherein the parameter is measured by analyzing the user's keyboard and mouse usage.

9. Method according to claim 6 wherein the predefined value is determined based on a personal user pattern.

10. Method according to claim 5 wherein the parameter is a physiological parameter of the user.

11. Method according to claim 1 comprising the further step of enabling the user to choose a mental exercise from a collection of mental exercises.

12. Method according to claim 1 comprising the further step of inhibiting the performance of any further actions by the user until he has completed the mental exercise.

13. Method according to claim 1 wherein the method is used for reducing stress of computer users.

14. A computer program comprising computer program code means adapted to perform the method of claim 1, when said program is run on a computer.

15. A computer program as claimed in claim 14 embodied on a computer readable medium.

16. A carrier medium carrying the computer program of claim 14.

17. System (100) for reducing stress comprising:
determining means (110) for determining if a break is to be proposed to a user;
invitation means (110) for inviting the user to do a mental exercise, when the break is proposed to the user.

18. System (100) according to claim 17, wherein the system is a computer system.
